(19) United States
(12) Patent Application Publication
(10) Pub. No.: US 2009/0105993 A1
(43) Pub. Date: Apr. 23, 2009

(54) HISTOGRAM GENERATION WITH MULTIPLE INCREMENT READ-MODIFY-WRITE CYCLES

(75) Inventor: Michael Frank JONES, Santa Clara, CA (US)

Correspondence Address: MORRISON & FOERSTER, LLP, 555 WEST FIFTH STREET, SUITE 3500, LOS ANGELES, CA, 90013-1024, US

(73) Assignee: ADVANTEST CORPORATION, Tokyo (JP)

(21) Appl. No.: 11/876,698

(22) Filed: Oct. 22, 2007

(51) Int. Cl. G06F 17/40

(52) U.S. Cl. 702/187

(57) ABSTRACT

Performing multiple increments to the count of a particular code in a single RMW cycle is disclosed when gathering histogram data. To accomplish this, a duplicate sample removal circuit receives a current code and one or more future codes from a device in a pipelined fashion, determines if any of the future codes are the same as the current code, and if they are, provides an increment value to an adder indicative of the current code plus the total number of future codes that match the current code. The output of the adder is then written back to the memory location specified by the current code. The duplicate sample removal circuit also “removes” those codes that have already been counted as part of a larger increment by de-asserting a write enable line to a memory element such as a dual port RAM.

### FIELD OF THE INVENTION

This invention relates to the generation of histograms, and more particularly, to performing multiple increments to the count of a particular code in a single read-modify-write (RMW) cycle when gathering histogram data to enable the gathering of histogram data at a faster rate.

### BACKGROUND OF THE INVENTION

Certain semiconductor devices capable of generating a semi-predictable multi-bit output in response to a known input stimulus can be tested by applying the known stimulus over a fixed period of time, and capturing the number of occurrences of particular multi-bit outputs during that time. Each particular multi-bit output being monitored may be referred to as a “bin,” and the number of counts in each bin at the conclusion of the fixed test period can be used to generate a histogram. The histogram can be used in various ways (e.g. numerical analysis) to determine if the device under test (DUT) is acceptable or not, or determine performance parameters.

One such device capable of being tested in the above-described manner is an ADC. An ADC generates a multi-bit output (also referred to herein as a “code”) in response to an analog input signal. A common input stimulus used for testing ADCs is a sine wave, which is relatively easily generated in a “clean” manner (substantially free of spurious frequencies). When the sine wave is applied to the input of the ADC, the input signal varies between a minimum and maximum analog voltage level, and the ADC outputs a multi-bit digital signal in accordance with the analog voltage level. Over time, a histogram can be generated indicative of the acceptability of the ADC.

FIG. 1a illustrates an exemplary block diagram of a high level perspective of test system 100 that may be used to test DUTs and generate histograms as described above. It should be emphasized that FIG. 1a is only exemplary, and that many other test system configurations well-understood to those skilled in the art may also be used. In FIG. 1a, modules 102 may be functional units such as a reference generator, a digital pincard, an analog card, a device power supply (DPS), or instruments such as a waveform generator. The physical connections to modules 102 may be obtained through module connection enabler 104 that includes switch matrix network 106. Switch matrix network 106 may include logic, traces, and pins.

System controller 108 is typically the point of interaction for a user. System controller 108 provides a gateway to site controllers 110 and synchronization of the site controllers in a multi-site/multi-DUT environment. A system controller 108 and multiple site controllers 110 may operate in a master-slave configuration. System controller 108 controls the overall system operation and determines that functions that a particular site controller 110 should perform. Each site controller 110 is itself sufficient to test DUT 112. Site controller 110 controls and monitors the operation of various modules 102 within test site 114. Test site 114 is a collection of modules 102 that service the testing of a single DUT 112. Site controller 110 can control one or multiple test sites 114.

As described above, an input stimulus such as a sine wave may be supplied from a reference generator module (one of the modules 102 in test site 114) to DUT 112. A multi-bit output from the DUT can be fed back to another module 102, where a count of each multi-bit output received from the DUT is accumulated.

FIG. 1b illustrates exemplary test site 114 and DUT 112 in greater detail. In FIG. 1b, DUT 112 is an ADC, and module 102_A generates a sine wave that is fed into the input of the ADC. The ADC generates an N-bit digital output, which is connected to the address line of memory 116 within module 102_B. At every sample of the ADC, the N-bit digital output addresses memory 116, and the count stored at that address is read out, modified (incremented by one), and written back to that address (a read-modify-write or RMW cycle). As shown by exemplary plot 118, in a typical ADC, a sine wave input will result in a nonlinear distribution of counts, with a high number of counts at a small number of minimum and maximum codes/addresses (corresponding to the minimum and maximum values of the sine wave, where the sine wave inflects), and a low number of counts at a large majority of the other addresses (corresponding to those regions where the sine wave is transitioning from low-to-high or from high-to-low). The high number of counts may be hundreds or thousands of times higher than the low number of counts.

An inefficiency results from the amount of time it takes to perform a RMW cycle in memory. For example, a dual port RAM may take three clock cycles to read out a count from a particular address, increment the count, and write it back into memory. This latency limits the speed at which the test can be performed. This inefficiency is exacerbated when the same code is obtained in consecutive samples (as is common when the sine wave is at its minimum and maximum points), resulting in the need to perform multiple RMW cycles on the same address in memory in order to maintain the proper count.

Therefore, there is a need to improve the ability to perform multiple increments to the count of a particular code when gathering histogram data.

### SUMMARY OF THE INVENTION

Embodiments of the invention are directed to performing multiple increments to the count of a particular code in a single RMW cycle when gathering histogram data to enable the gathering of histogram data at a faster rate. To accomplish this, a duplicate sample removal circuit receives a current code and one or more future codes from a device in a pipelined fashion, determines if any of the future codes are the same as the current code, and if they are, provides an increment value to an adder indicative of the current code plus the total number of future codes that match the current code. The output of the adder is then written back to the memory location specified by the current code. As a result, the count originally stored at that memory location may be incremented by more than one in a single RMW cycle.

In addition to providing the increment value, the duplicate sample removal circuit also “removes” those codes that have already been counted as part of a larger increment by de-asserting a write enable line to a memory element such as a dual port RAM. By performing multiple increments in a single clock cycle rather than performing single increments in successive clock cycles, timing problems associated with RMW cycle delays are avoided, and the gathering of histogram data can proceed at a faster rate.

For every code that appears as a present code, the duplicate sample removal circuit looks ahead to a number of other future codes received after the present code, and attempts to increment the count for that present code by one plus the total number of future codes equal to the present code. However, whether the increment actually takes place is dependent on whether the write enable signal (wr) for that present code is asserted. It will be asserted if the present code was not counted in a previous increment, and it will be de-asserted if the present code was already counted in a previous increment.

### BRIEF DESCRIPTION OF THE DRAWINGS

FIG. 1a illustrates an exemplary block diagram of a test system that may be used to test DUTs and generate histograms.

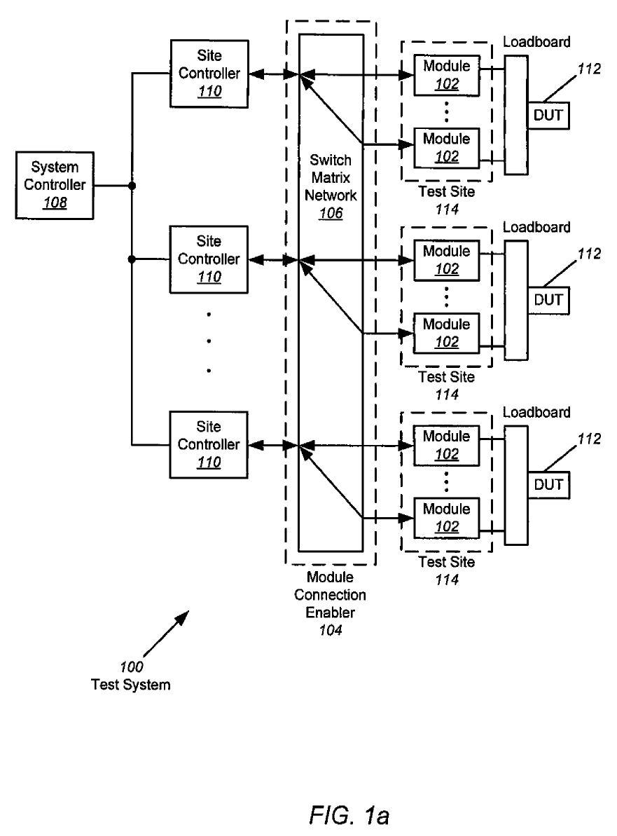

FIG. 1b illustrates an exemplary test site including modules for generating a sine wave and counting the number of occurrences of particular output codes.

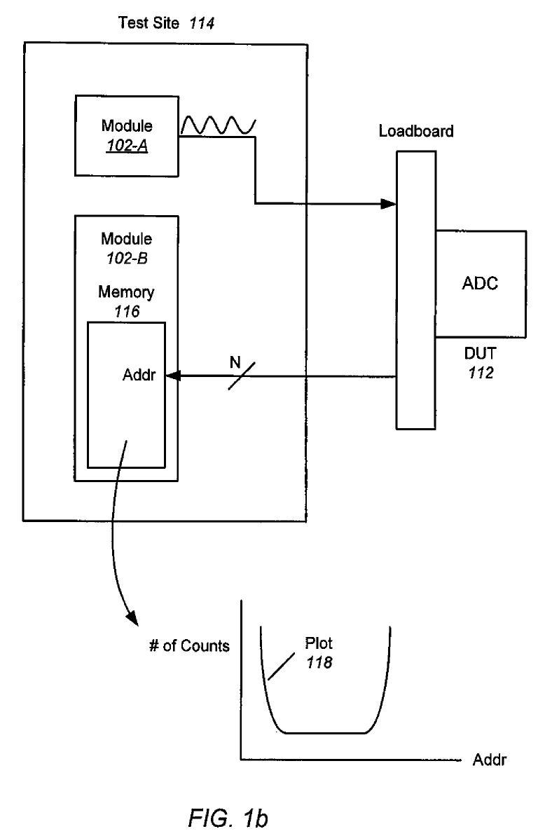

FIG. 2a illustrates an exemplary histogram memory circuit including RMW logic according to embodiments of the invention.

FIG. 2b illustrates an exemplary duplicate sample removal circuit according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

Embodiments of the invention are directed to performing multiple increments to the count of a particular code in a single RMW cycle when gathering histogram data to enable the gathering of histogram data at a faster rate. To accomplish this, a duplicate sample removal circuit receives a current code and one or more future codes from a device in a pipelined fashion, determines if any of the future codes are the same as the current code, and if they are, provides an increment value to an adder indicative of the current code plus the total number of future codes that match the current code. The output of the adder is then written back to the memory location specified by the current code. As a result, the count originally stored at that memory location may be incremented by more than one in a single RMW cycle.

In addition to providing the increment value, the duplicate sample removal circuit also “removes” those codes that have already been counted as part of a larger increment by de-asserting a write enable line to a memory element such as a dual port RAM. By performing multiple increments in a single clock cycle rather than performing single increments in successive clock cycles, timing problems associated with RMW cycle delays are avoided, and the gathering of histogram data can proceed at a faster rate.

It should be understood that although the present invention may be described herein in the context of testing one or more ADCs being driven with sine waves for purpose of illustration only, embodiments of the present invention are applicable to any device capable of generating a predictable multi-bit output in response to any known input stimulus, and are also applicable to the gathering of histogram data in non-test situations as well.

As described above, when an ADC generates a digital output value (code), this code is used as an address to a memory such as a RAM, and the value stored at that address is incremented by one using a technique called RMW, which generally takes several clock cycles to complete. At the minimum and maximums of an input sine wave, the same digital output value may be produced by the ADC a number of times in succession, and the memory would have to perform a RMW cycle a number of times in rapid succession to maintain a proper count. Because each RMW cycle takes several clock cycles to complete, it can take a relatively large number of clock cycles to perform a number of successive single increments to the value stored at a particular address.

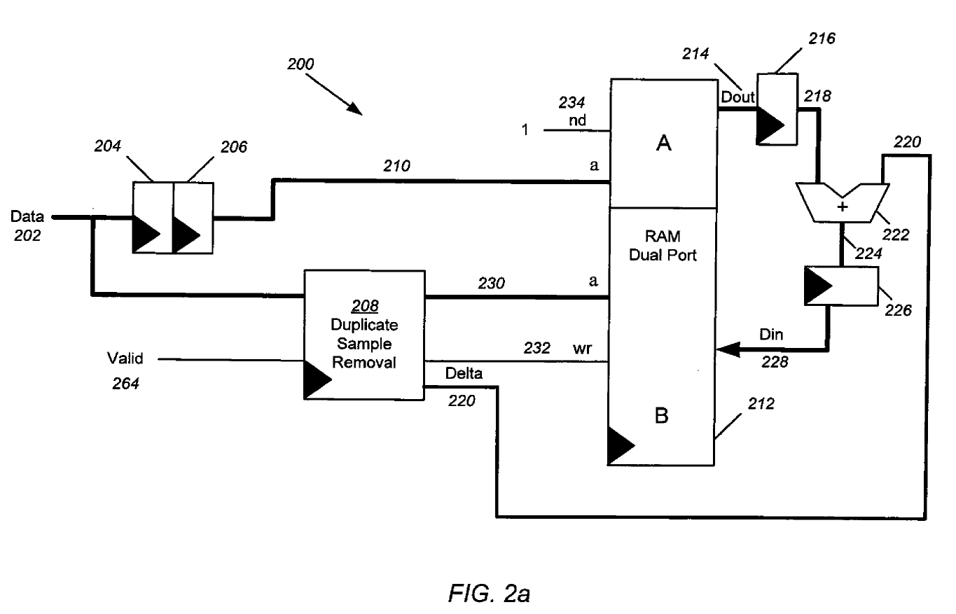

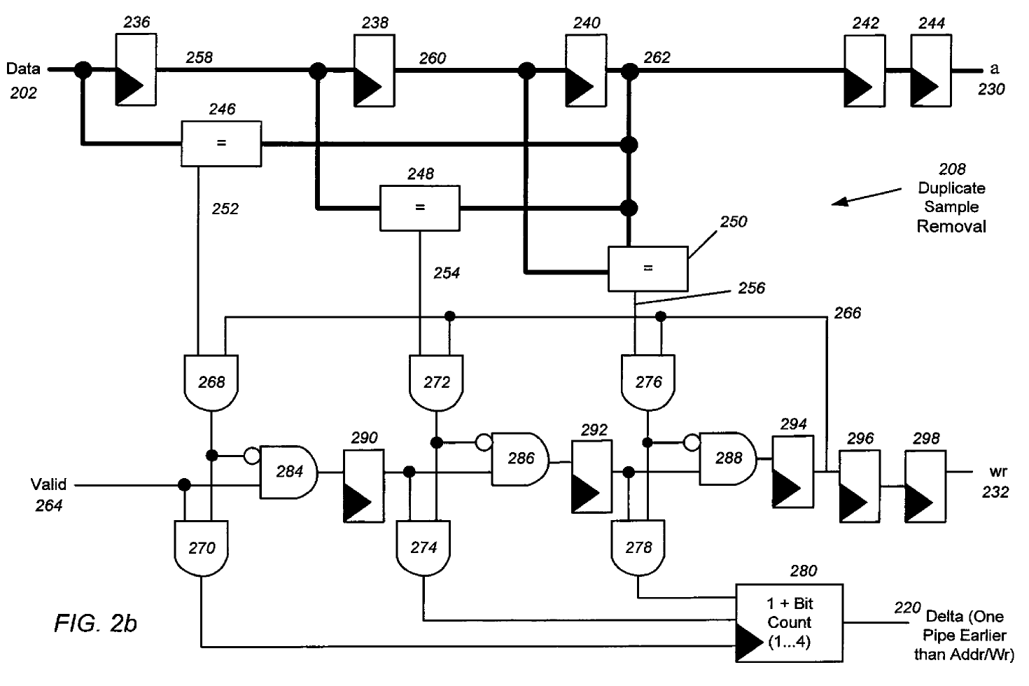

FIG. 2a illustrates an exemplary histogram memory circuit 200 including RMW logic according to embodiments of the invention. In FIG. 2a, data or code 202 from an ADC is first clocked through pipeline stages 204 and 206 to match the pipeline stages in duplicate sample removal logic 208, discussed in further detail below. The delayed data 210 is then presented to the address lines of port A of a dual port RAM 212 or other memory device with similar characteristics. Data 214 at that address is read out of port A (because read enable 234 is always asserted), and clocked through pipeline stage 216. Clocked data 218 is then added to an increment value 220 from duplicate sample removal circuit 208 using adder 222, and sum 224 is clocked through pipeline stage 226, where the output 228 is presented as a data input to port B. Output 228 is then written at Port B to the location specified by the address 230 received from the duplicate sample removal circuit 208, but only if the write enable line (wr) 232 is asserted. The stage 216, adder 222, and stage 226 may be referred to herein as a RMW circuit.

In general, duplicate sample removal circuit 208 receives a current code and one or more future codes in a pipelined fashion, determines if any of the future codes is the same as the current code, and if they are, provides an increment value 220 to the adder 222 indicative of the current code plus the total number of future codes that match the current code. In addition to providing the increment value 220, duplicate sample removal circuit 208 also “removes” those codes that have already been counted as part of a larger increment by de-asserting the wr line. By performing multiple increments in a single clock cycle rather than performing single increments in successive clock cycles, timing problems associated with RMW cycle delays are avoided, and the gathering of histogram data can proceed at a faster rate.

For example, if the pipeline contained three future codes and a current code, and none of the future codes matched the current code, increment value 220 would be one (because the current code was only found once in the pipeline). Because none of the future codes were counted in the increment value, the write enable line 232 will not be de-asserted during a future clock cycle as a result of a matching future code. If one of the future codes, in any order, matched the current code, increment value 220 would be two (because the current code was found twice in the pipeline). In addition, because one of the future codes was counted in the increment value, the write enable line 232 will be de-asserted during the future clock cycle associated with the matching future code. If any two of the future codes matched the current code, increment value 220 would be three (because the current code was found three times in the pipeline). In addition, because two of the future codes were counted in the increment value, the write enable line 232 will be de-asserted during the two future clock cycles associated with the two matching future codes. Finally, if all three future codes matched the current code, increment value 220 would be four (because the current code was found four times in the pipeline). In addition, because three of the future codes were counted in the increment value, the write enable line 232 will be de-asserted during the three future clock cycles associated with the three matching future codes.

FIG. 2b illustrates an exemplary duplicate sample removal circuit 208 according to embodiments of the invention. In FIG. 2b, code 202 is clocked through pipelined stages 236, 238, 240, 242 and 244 to generate address 230. Note that the number of pipeline stages in the duplicate sample removal circuit 208 in FIG. 2b are the same as the number of stages it takes for the incremented value to appear as an input to port B in FIG. 2a. Digital magnitude comparators 246, 248 and 250 generate an asserted future code 202, second future code 258, or first future code 260, respectively, or generate a de-asserted signal otherwise.

Under normal conditions when the valid input 264 is asserted and intermediate write (IW) signal 266 is also asserted, any asserted comparator output 252, 254 or 256 will assert the output of AND gate pairs 268 and 270, 272 and 274, or 276 and 278, respectively, and therefore assert an input to the “1+bit count” block 280. This block 280 adds up the number of asserted inputs, adds one, and outputs this value as increment value 220.

At the same time, when the output of any one or more of AND gates 268, 272 or 276 is asserted, the output of one or more of gates 284, 286 or 288, respectively, is de-asserted, and each de-assertion is then clocked through to flip-flops 290, 292 and 294, respectively. Each de-asserted flip-flop 290, 292 or 294 causes IW 266 to be de-asserted for one clock cycle, the particular clock cycle ultimately dependent on which of comparator outputs 252, 254 and 256 were asserted. These de-assertions of IW 266, after being clocked out through pipeline stages 296 and 298 to write enable line 232, cause port B of the dual port RAM to be write-disabled for certain clocks, which has the effect of ignoring further increments for those codes already taken care of during the multiple-value increment.

Note that FIG. 2b utilizes three look-aheads (i.e. three future codes), because three clock cycles are needed to perform the RMW operation. However, if more or fewer clock cycles were needed, more or fewer lookaheads will be required.

In general, for every code that appears as a present code, the logic looks ahead to three other future codes received after the present code, and attempts to increment the count for that present code by one plus the total number of future codes equal to the present code. However, whether the increment actually takes place is dependent on whether the write enable signal (wr) for that present code is asserted. It will be asserted if the present code was not counted in a previous increment, and it will be de-asserted if the present code was already counted in a previous increment.

It should be understood by those skilled in the art that FIGS. 2a and 2b are simplified for purposes of clarity, and that various elements such as a clock distribution network to the registers and memories, and access paths to the memories so that histogram results can be retrieved, are not shown in the figures. In addition, a mechanism for clearing the memories is needed to clear them prior to the start of a test. Furthermore, it should also be understood that the logic designs of FIGS. 2a and 2b are merely exemplary, and that other circuits capable of performing the same functions may be utilized within the scope of this invention.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. An apparatus for generating an increment value capable of being used to perform multiple increments to a count of a current code received from a device in a single read-modify-write (RMW) cycle when gathering histogram data, comprising:
a duplicate sample removal circuit configured for
receiving the current code and one or more future codes from the device in a pipelined fashion, and
determining if any of the future codes match the current code, and if they do, computing the increment value, the increment value equal to one plus a total number of the future codes that match the current code.

2. The apparatus of claim 1, further comprising:
a RMW circuit coupled to the duplicate sample removal circuit and configured for
receiving a read value from a location in a memory specified by the current code,
receiving the increment value from the duplicate sample removal circuit, and
generating a write value equal to the increment value plus the read value, the write value capable of being written back to the location in memory specified by the current code.

3. The apparatus of claim 1, the duplicate sample removal circuit further configured for removing those future codes that have been already counted in the increment value by de-asserting a write enable line to the memory during clock cycles associated with the previously counted future codes.

4. The apparatus of claim 1, the duplicate sample removal circuit further configured for comparing each of the one or more future codes with the current code to determine how many of the future codes are the same as the present code.

5. The apparatus of claim 4, the duplicate sample removal circuit further configured for de-asserting a stage in a pipelined write enable line corresponding a future code when that future code is found to match the current code to remove those future codes that have been already counted in the increment value.

6. The apparatus of claim 1, further comprising a memory coupled to the duplicate sample removal circuit and the RMW circuit and configured for providing the read value from the location in the memory specified by the current value and writing the write value back to that location.

7. A test site comprising the apparatus of claim 5.

8. A test system comprising the test site of claim 6.

9. A method for generating an increment value capable of being used to perform multiple increments to a count of a current code received from a device in a single read-modify-write (RMW) cycle when gathering histogram data, comprising:
receiving the current code and one or more future codes from the device in a pipelined fashion, and
determining if any of the future codes match the current code, and if they do, computing the increment value, the increment value equal to one plus a total number of the future codes that match the current code.

10. The method of claim 9, further comprising:
receiving a read value from a location in a memory specified by the current code;
receiving the increment value from the duplicate sample removal circuit; and
generating a write value equal to the increment value plus the read value, the write value capable of being written back to the location in memory specified by the current code.

11. The method of claim 9, further comprising removing those future codes that have been already counted in the increment value by de-asserting a write enable line to the memory during clock cycles associated with the previously counted future codes.

12. The method of claim 9, further comprising comparing each of the one or more future codes with the current code to determine how many of the future codes are the same as the present code.

13. The method of claim 12, further comprising de-asserting a stage in a pipelined write enable line corresponding a future code when that future code is found to match the current code to remove those future codes that have been already counted in the increment value.

14. The method of claim 1, further comprising:
coupling a memory to the duplicate sample removal circuit and the RMW circuit; and
providing the read value from the location in the memory specified by the current value and writing the write value back to that location.

15. A method for generating an increment value capable of being used to perform multiple increments to a count of a current code received from a device in a single read-modify-write (RMW) cycle when gathering histogram data, comprising:
looking ahead to one or more future codes received after a present code in a pipelined fashion; and
for every future code that matches the present code, computing the increment value as one plus a total number of the future codes that match the current code.

16. The method of claim 15, further comprising incrementing a count stored in a location in memory specified by the current code by the increment value.

17. The method of claim 16, further comprising incrementing the count by the increment value only if a write enable line is asserted.

18. The method of claim 17, further comprising de-asserting the write enable line if the current code was already counted in a previously generated increment value.
